(19) United States
(12) Patent Application Publication
(10) Pub. No.: US 2011/0258444 A1
(43) Pub. Date: Oct. 20, 2011

(54) Network Controller Decryption

(75) Inventor: Ronen Chayat, Haifa (IL)

(73) Assignee: Intel Corporation, Santa Clara, CA (US)

(21) Appl. No.: 12/974,139

(22) Filed: Dec. 21, 2010

Related U.S. Application Data
(63) Continuation of application No. 09/364,375, filed on Jul. 30, 1999.

(51) Int. Cl. H04L 9/32

(52) U.S. Cl. 713/168

(57) ABSTRACT

A system for selectively transmitting packets involves marking a plurality of packets coming into a transmit queue with an indicator of a packet type. Some packet types may take longer to process than others. For example, packets associated with security protocols may take a longer time to process than those that do not involve security processing. A dispatcher may determine based on the marking of the packet whether it is a security or a non-security packet and may determine when to transmit the packet based on that information.

### CROSS-REFERENCE TO RELATED APPLICATIONS

This application is a continuation of U.S. patent application Ser. No. 09/364,375, filed on Jul. 30, 1999.

### BACKGROUND

The invention relates to selectively transmitting one type of packet ahead of another in a computer system, for example in connection with a network controller.

Referring to FIG. 1, a server 12 may communicate with a client 10 by transmitting packets 8 of information over a network 18 pursuant to a network protocol. As an example, the network protocol may be a Transmission Control Protocol/Internet Protocol (TCP/IP), and as a result, the client 10 and server 12 may implement protocol stacks, such as TCP/IP stacks 17 and 19, respectively. For the client 10 (as an example), the TCP/IP stack 17 conceptually divides the client's software and hardware protocol functions into five hierarchical layers 16 (listed in hierarchical order): an application layer 16a (the highest layer), a transport layer 16b, a network layer 16c, a data link layer 16d and a physical layer 16e (the lowest layer).

More particularly, the physical layer 16e typically includes hardware (a network controller, for example) that establishes physical communication with the network 18 by generating and receiving signals (on a network wire 9) that indicate bits of the packets 8. The physical layer 16e recognizes bits and does not recognize packets, as the data link layer 16d performs this function. In this manner, the data link layer 16d typically is both a software and hardware layer that may, for transmission purposes, cause the client 10 to package the data to be transmitted into the packets 8. For purposes of receiving packets 8, the data link layer 16d may, as another example, cause the client 10 to determine the integrity of the incoming packets 8 by determining if the incoming packets 8 generally conform to predefined formats and if the data of the packets comply with checksums of the packets, for example.

The network layer 16c typically is a software layer that is responsible for routing the packets 8 over the network 18. In this manner, the network layer 16c typically causes the client 10 to assign and decode Internet Protocol (IP) addresses that identify entities that are coupled to the network 18, such as the client 10 and the server 12. The transport layer 16b typically is a software layer that is responsible for such things as sequencing, error control and general flow control of the packets 8. The transport layer 16b may cause the client 10 to implement the specific network protocol, such as the TCP/IP protocol or a User Datagram Protocol (UDP), as examples. The application layer 16a typically includes network applications that, upon execution, cause the client 10 to generate and receive the data of the packets 8.

Referring to FIG. 2, a typical packet 8 may include an IP header 20 that indicates such information as the source and destination IP addresses for the packet 8. The packet 8 may also include a protocol header 22 (a TCP or an UDP protocol header, as examples) that is specific to the network protocol being used. As an example, a TCP protocol header might indicate a TCP destination port and a TCP source port that uniquely identify the applications that cause the client 10 and server 12 to transmit and receive the packets 8. The packet 8 may also include a data portion 24, the contents of which are furnished by the source application. The packet 8 may include additional information, such as a trailer 26, for example, that is used in connection with encryption of the data portion 24.

Referring to FIG. 3, as an example, a TCP protocol header 22a may include a field 30 that indicates the TCP source port address and a field 32 that indicates the TCP destination port address. Another field 34 of the TCP protocol header 22a may indicate a sequence number that is used to concatenate packets of an associated flow. In this manner, packets 8 that have the same LP addresses, port addresses and security attributes are typically part of the same flow, and the sequence number indicates the order of a particular packet 8 in that flow. Thus, as an example, a packet 8 with a sequence number of “244” typically is transmitted before a packet 8 with a sequence number of “245.”

In addition to the packets 8 of a particular flow being sequentially numbered, the data bytes of the flow may be sequentially numbered even though the data bytes may be divided among the different packets 8 of the flow. To accomplish this, a field 36 of the TCP protocol header 22a may indicate an acknowledgment number that identifies the first byte number of the next packet 8. Therefore, if the last byte of data in a particular packet 8 has a byte number of “1000,” then the acknowledgment number for this packet 8 is “1001” to indicate the first byte in the next packet 8 of the flow.

The TCP protocol header 22a may include a field 38 that indicates a length of the header 22a, a field 44 that indicates a checksum for the bytes in the header 22a and a field 40 that indicates control and status flags. For example, the field 40 may indicate whether the packet 8 is the first or last packet 8 of a particular flow. As another example, the field 40 may indicate whether or not a particular packet 8 is an acknowledgment packet, a packet used for purposes of “handshaking.” In this manner, an acknowledgment packet typically does not (but may) include data, and the receiver of a flow transmits an acknowledgment packet after the receiver receives a predetermined number (two, for example) of packets from the sender. In this manner, the receipt of an acknowledgment packet by the sender indicates that a predetermined number of packets were successfully transmitted. The TCP protocol header 22a may also include a field 42 that indicates a maximum number of bytes (called a “window”) that the sender may transmit before receiving an acknowledgment packet that indicates a least some of the bytes were successively transmitted.

Network controller commonly use a first in first out (FIFO) memory. When the FIFO memory must handle different types of frames such as security frames and non-security frames, blockages may occur. For example, security frames which involve either encryption or authentication may delay the transmission of regular frames that require no special processing. When the serial FIFO memory processes a frame or transmission that takes an excessive amount of time, the remaining frames (which do not need special processing) are similarly blocked.

Thus, it would desirable to have a technique to improve the processing of frames of different types.

### SUMMARY

In accordance with one embodiment, a method for use with a computer system includes receiving packets of at least two types. Packets of one type may be transmitted ahead of packets of the other type.

### BRIEF DESCRIPTION OF THE DRAWING

FIG. 1 is a schematic diagram of a network of computers according to the prior art.

FIG. 2 is a schematic diagram of a packet transmitted over the network shown in FIG. 1.

FIG. 3 is an illustration of an exemplary protocol header of the packet of FIG. 2.

FIG. 4 is a schematic diagram of a computer system according to an embodiment of the invention.

FIG. 5 is a schematic diagram of a network controller of FIG. 4.

FIG. 6 is an illustration of a flow tuple stored in memory of the network controller of FIG. 5.

FIG. 7 is a schematic diagram illustrating the transfer of packet data according to an embodiment of the invention.

FIG. 8 is a schematic diagram illustrating the transfer of packet data between layers of the network stack of the prior art.

FIGS. 9 and 10 are flow diagrams illustrating parsing of packet data by a receive parser of the network controller of FIG. 5.

FIG. 11 is a flow diagram illustrating operation of a zero copy parser of the network controller of FIG. 5 according to an embodiment of the invention.

FIG. 12 is a flow diagram illustrating operation of a security frame queue control circuit of the network controller of FIG. 5 according to an embodiment of the invention.

FIG. 13 is a flow diagram illustrating operation of a non-security frame queue control circuit of the network controller of FIG. 5 according to an embodiment of the invention.

FIG. 14 is a flow diagram illustrating operation of a packet dispatcher circuit of the network controller of FIG. 5 according to an embodiment of the invention.

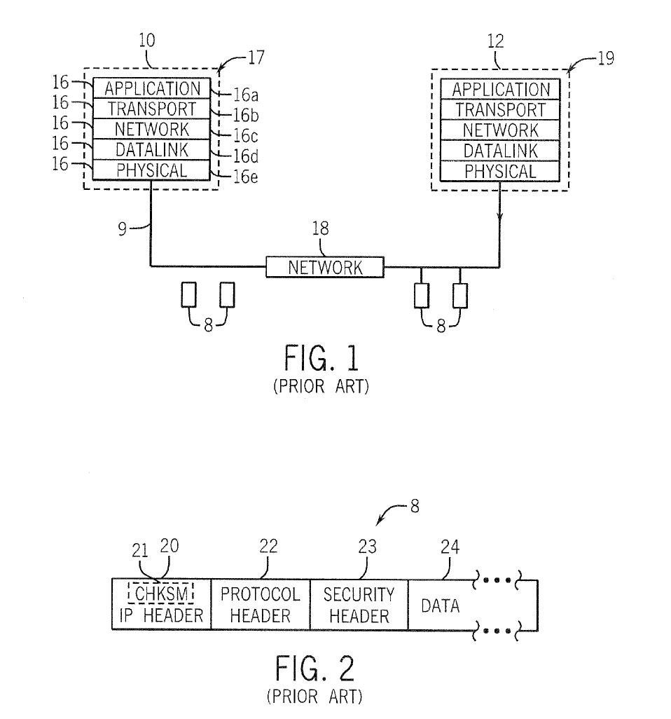

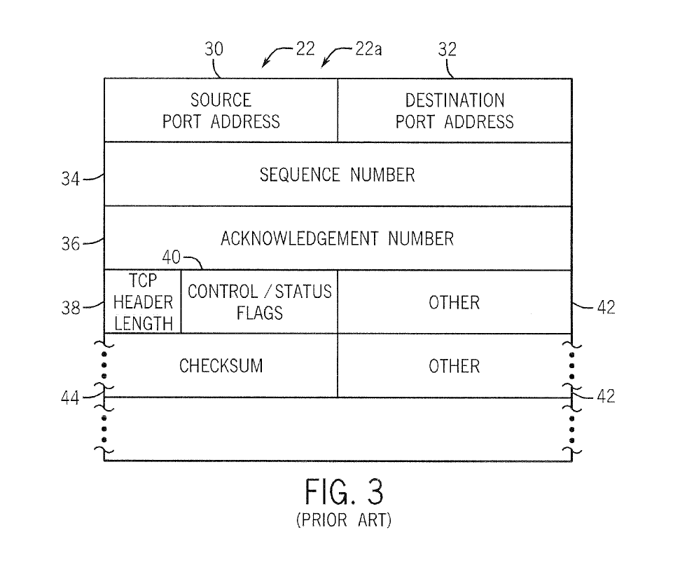

### DETAILED DESCRIPTION

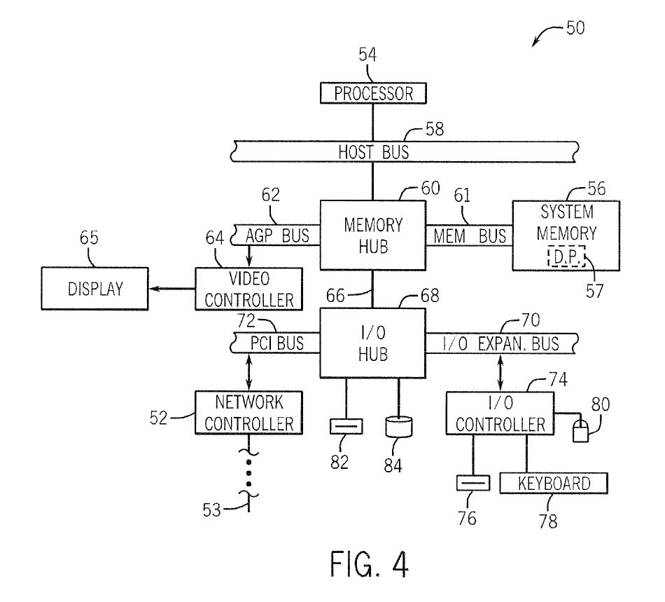

Referring to FIG. 4, an embodiment 50 of a computer system in accordance with the invention includes a network controller 52 (a local area network (LAN) controller, for example) that communicates frames, or packets, of information with other networked computer systems via at least one network wire 53. Unlike conventional network controllers, the network controller 52 may be adapted in one embodiment of the invention to perform functions that are typically implemented by a processor (a central processing unit (CPU), for example) that executes one or more software layers (a network layer and a transport layer, as examples) of a protocol stack (a TCP/IP stack, for example). As an example, these functions may include parsing headers of incoming packets to obtain characteristics (of the packet) that typically are extracted by execution of the software layers. The characteristics, in turn, may be used to identify a flow that is associated with the packet, as further described below.

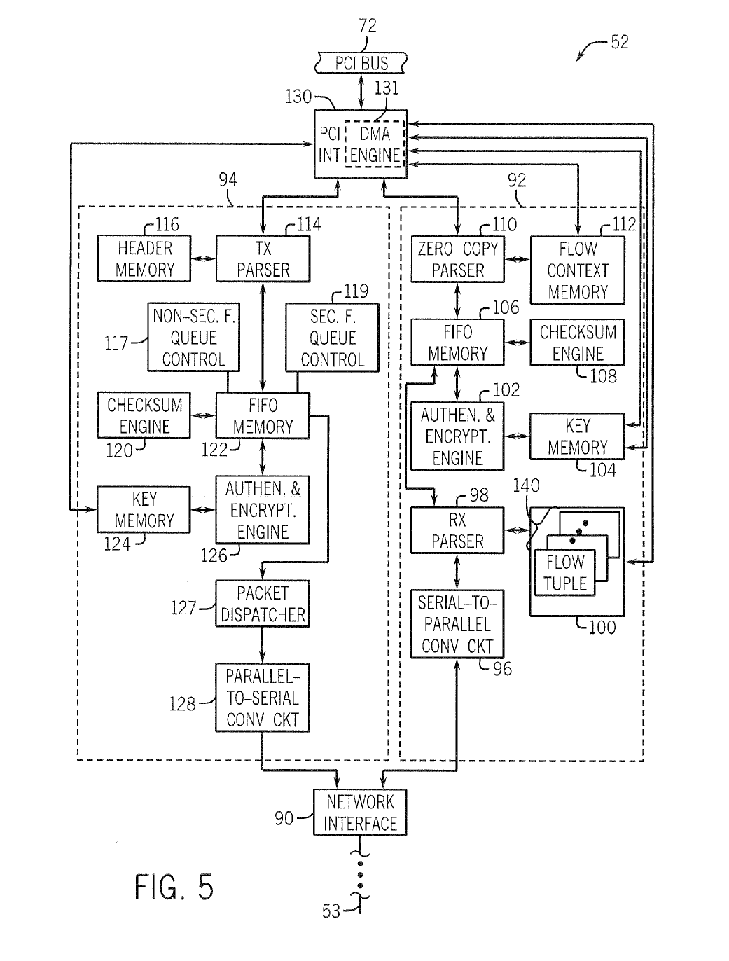

Referring to FIG. 5, the network controller 52 may include hardware, such as a receive path 92, to perform traditional software functions to process packets that are received from the network. For example, the receive path 92 may include a receive parser 98 to parse a header of each packet to extract characteristics of the packet, such as characteristics that associate a particular flow with the packet. Because the receive path 92 may be receiving incoming packets from many different flows, the receive path 92 may include a memory 100 that stores entries, or flow tuples 140, that uniquely identify a particular flow. In this manner, the receive parser 98 may interact with the memory 100 to compare parsed information from the incoming packet with the stored flow tuples 140 to determine if the flow if detected, or “flow tuple hit,” occurs. If a flow tuple hit occurs, the receive parser 98 may indicate this event to other circuitry (of the controller 52) that processes the packet based on the detected flow, as further described below.

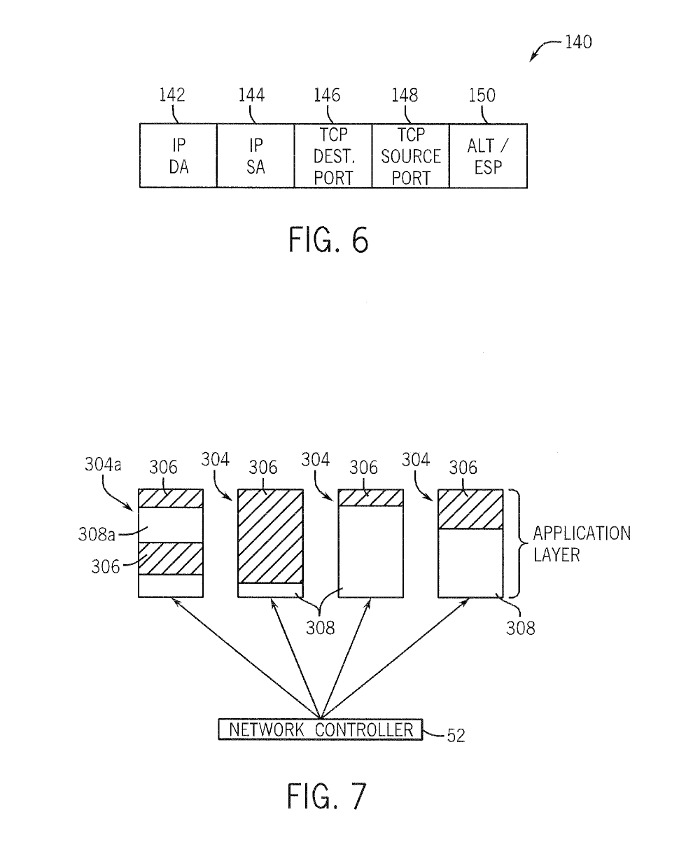

Referring also to FIG. 6, each flow tuple 140 may include fields that identify characteristics of a particular flow. As an example, in some embodiments, at least one of the flow tuples 140 may be associated with a Transmission Control Protocol (TCP) and may include a field 142 that indicates an internet protocol (IP) destination address (i.e., the address of the computer system to receive the packet); a field 144 that indicates an IP source address (i.e., the address of a computer system to transmit the packet); a field 146 that indicates a TCP destination port (i.e., the address of the application that caused generation of the packet); a field 148 that indicates a TCP source port (i.e., the address of the application that is to receive the packet); and a field 150 that indicates security/authentication attributes of the packet. Other flow tuples 140 may be associated with other network protocols, such as a User Datagram Protocol (UDP), for example. The above references to specific network protocols are intended to be examples only and are not intended to limit the scope of the invention. Additional flow tuples 140 may be stored in the memory 100 and existing flow tuples 140 may be removed from the memory 100 via a driver program 57 (FIG. 4).

If the receive parser 98 recognizes (via the flow tuples 140) the flow that is associated with the incoming packet, then the receive path 92 may further process the packet. If the receive parser 98 does not recognize the flow, then the receive path 92 passes the incoming packet via a Peripheral Component Interconnect (PCI) interface 130 to software layers of a TCP/IP stack of the computer system 50 for processing. The PCI Specification is available from The PCI Special Interest Group, Portland, Oreg. 97214. In this manner, in some embodiments, the computer system 50 may execute an operating system that provides at least a portion of some layers (network and transport layers, for example) of the protocol stack.

In some embodiments, even if the receive parser 98 recognizes the flow, additional information may be needed before receive path 92 further processes the incoming packet 52. For example, an authentication/encryption engine 102 may authenticate and/or decrypt the data portion of the incoming packet based on the security attributes that are indicated by the field 150 (see FIG. 6). In this manner, if the field 150 indicates that the data portion of the incoming packet is encrypted, then the engine 102 may need a key to decrypt the data portion.

For purposes of providing the key to the engine 102, the network controller 52 may include a key memory 104 that stores different keys that may be indexed by the different associated flows, for example. Additional keys may be stored in the key memory 104 by execution of the driver program 57, and existing keys may be removed from the key memory 104 by execution of the driver program 57. In this manner, if the engine 102 determines that the particular decryption key is not stored in the key memory 104, then the engine 102 may submit a request (via the PCI interface 130) to the driver program 57 (see FIG. 4) for the key. In this manner, the driver program 57, when executed, may furnish the key in response to the request and interact with the PCI interface 130 to store the key in the key memory 104. In some embodiments, if the key is unavailable (i.e., the key is not available from the driver program 57 or is not stored in the key memory 104), then the engine 102 does not decrypt the data portion of the packet. Instead, the PCI interface 130 stores the encrypted data in a predetermined location of a system memory 56 (see FIG. 4) so that software of one or more layers of the protocol stack may be executed to decrypt the data portion of the incoming packet.

After the parsing, the processing of the packet by the network controller 52 may include bypassing the execution of one or more software layers of the protocol stack. For example, the receive path 92 may include a zero copy parser 110 that, via the PCI interface 130, copies data associated with the packet into a memory buffer 304 (see FIG. 7) that is associated with the application. In this manner, several applications may have associated buffers for receiving the packet data. The operating system creates and maintains the buffers 304 in a virtual address space, and the operating system reserves a multiple number of physical four kilobyte (KB) pages for each buffer 304. The operating system also associates each buffer with a particular application. This arrangement is to be contrasted to conventional arrangements that may use intermediate buffers to transfer packet data from the network controller to applications, as described below.

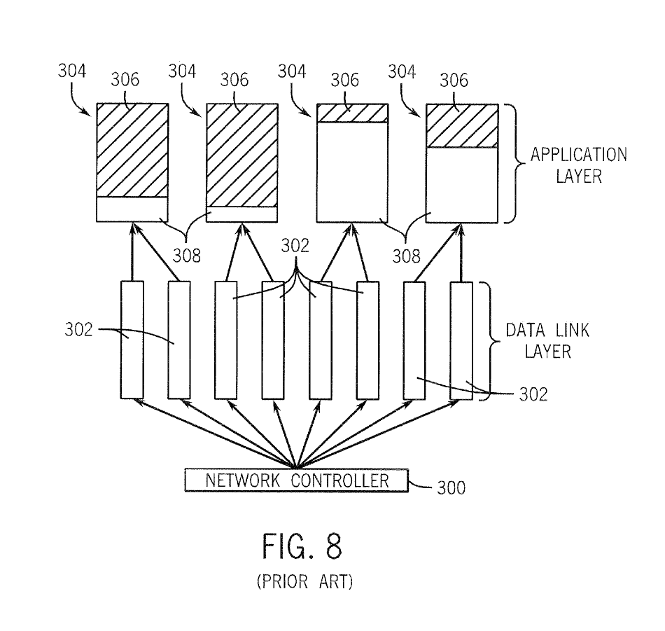

Referring to FIG. 8, for example, a typical network controller 300 does not directly transfer the packet data into the buffers 304 because the typical network controller 300 does not parse the incoming packets to obtain information that identifies the destination application. Instead, the typical network controller 300 (under the control of the data link layer, for example) typically transfers the data portion of the packet into packet buffers 302 that are associated with the network layer. In contrast to the buffers 304, each buffer 302 may have a size range of 64 to 1518 bytes. The execution of the network layer subsequently associates the data with the appropriate applications and causes the data to be transferred from the buffers 302 to the buffers 304.

Referring back to FIG. 7, in contrast to the conventional arrangement described above, the network controller 52 may use the zero copy parser 110 to bypass the buffers 302 and copy the data portion of the packet directly into the appropriate buffer 304. To accomplish this, the zero copy parser 110 (see FIG. 5) may receive an indication of the TCP destination port (as an example) from the receive parser 98 that, as described above, extracts this information from the header. The TCP destination port uniquely identifies the application that is to receive the data and thus, identifies the appropriate buffer 304 for the packet data. Besides transferring the data portions to the buffers 304, the zero copy parser 110 may handle control issues between the network controller and the network stack and may handle cases where an incoming packet is missing, as described below.

Referring to FIG. 5, besides the components described above, the receive path 92 may also include one or more first-in-first-out (FIFO) memories 106 to synchronize the flow of incoming packets through the receive path 92. A checksum engine 108 (of the receive path 92) may be coupled to one of the FIFO memories 106 for purposes of verifying checksums that are embedded in the packets. The receive path 92 may be interfaced to a PCI bus 72 via the PCI interface 130. The PCI interface 130 may include an emulated direct memory access (DMA) engine 131. In this manner, for purposes of transferring the data portions of the packets directly into the buffers 304, the zero copy parser 110 may use one of a predetermined number (sixteen, for example) of emulated DMA channels to transfer the data into the appropriate buffer 304. In some embodiments, it is possible for each of the channels to be associated with a particular buffer 304. However, in some embodiments, when the protocol stack (instead of the zero copy parser 110) is used to transfer the data portions of the packets the DMA engine 131 may use a lower number (one, for example) of channels for these transfers.

In some embodiments, the receive path 92 may include additional circuitry, such as a serial-to-parallel conversion circuit 96 that may receive a serial stream of bits from a network interface 90 when a packet is received from the network wire 53. In this manner, the conversion circuit 96 packages the bits into bytes and provides these bytes to the receive parser 98. The network interface 90 may be coupled to generate and receive signals to/from the wire 53.

In addition to the receive path 92, the network controller 52 may include other hardware circuitry, such as a transmit path 94, to transmit outgoing packets to the network. In the transmit path 94, the network controller 52 may include a transmit parser 114 that is coupled to the PCI interface 130 to receive outgoing packet data from the computer system 50 and form the header on the packets. To accomplish this, in some embodiments, the transmit parser 114 stores the headers of predetermined flows in a header memory 116. Because the headers of a particular flow may indicate a significant amount of the same information (port and IP addresses, for example), the transmit parser 114 may slightly modify the stored header for each outgoing packet and assemble the modified header onto the outgoing packet. As an example, for a particular flow, the transmit parser 114 may retrieve the header from the header memory 116 and parse the header to add such information as sequence and acknowledgment numbers (as examples) to the header of the outgoing packet. A checksum engine 120 may compute checksums for the IP and network headers of the outgoing packet and incorporate the checksums into the packet.

In transmitting different types of packets, one type of packet may take more time to process than another type of packet. This delay, in turn, may stall the pipeline used to process the outgoing packets. For example, security packets must wait for encryption or authentication processing before they are transmitted because this information goes into the header. When the FIFO memory 122 stores both security and non-security packets, the security packets may take more processing time, blocking the transmission of the non-security packets.

However, in some embodiments, the transmit path 94 may include circuitry to allow non-security packets to be fetched from the FIFO memory 122 and transmitted ahead of security packets to increase the rate of transmission. More particularly, the FIFO memory 122 may be organized in a linked-list structure of packet blocks in a manner that reflects the order in which the packets entered the FIFO memory 122. In some embodiments, each packet block is marked on entry to the FIFO memory 122 as either being a security packet or a non-security packet, depending the security attributes that are indicated by the IP header that is associated with the packet. An authentication and security engine 126 follows the linked-list within the FIFO memory 122 and processes security packets when present.

A non-security packet queue control circuit 117 may search through the FIFO memory 122 to find a tag that identifies a non-security packet, and a security packet queue control circuit 119 may search through the FIFO memory 122 to find a tag that identifies a security packet. In this manner, when the non-security packet queue control circuit 117 locates the next non-security packet, the circuit 117 provides a pointer to a packet dispatcher circuit 127 that points to the non-security packet, and the circuit 117 signals the packet dispatcher circuit 127 to indicate the availability of the next pointer. The circuit 117 subsequently waits for an acknowledgment from the packet dispatcher 127 before finding the next non-security packet.

When the security packet queue control circuit 119 finds the next security packet that has been processed by the authentication and security engine 126, the circuit 119 provides a pointer to a packet dispatcher circuit 127 that points to the security packet. The circuit 119 then signals the packet dispatcher circuit 127 to indicate the availability of the next pointer. The circuit 119 subsequently waits for an acknowledgment from the packet dispatcher 127 before finding the next security packet.

In response to the signals from the non-security packet queue control circuit 117 and the security packet queue control circuit 119, the packet dispatcher circuit 127 selects one of the two provided pointers, retrieves the packet from the FIFO memory 122 and furnishes the packet to a parallel-to-serial conversion circuit 128 that is coupled to the network interface 90. Thus, if a particular security packet is present in the FIFO memory 122 but has not been processed, the security packet does not prevent a non-security packet from being transmitted.

In some embodiments, if both the non-security packet queue control circuit 117 and the security packet queue control circuit 119 concurrently provide new pointers to the packet dispatcher circuit 127, then the packet dispatcher circuit 127 selects one of the pointers based on a round robin priority basis. In this manner, the packet dispatcher circuit 127 may select the non-security packet pointer one time, select the security packet pointer the next time, select the non-security packet pointer the next time, etc.

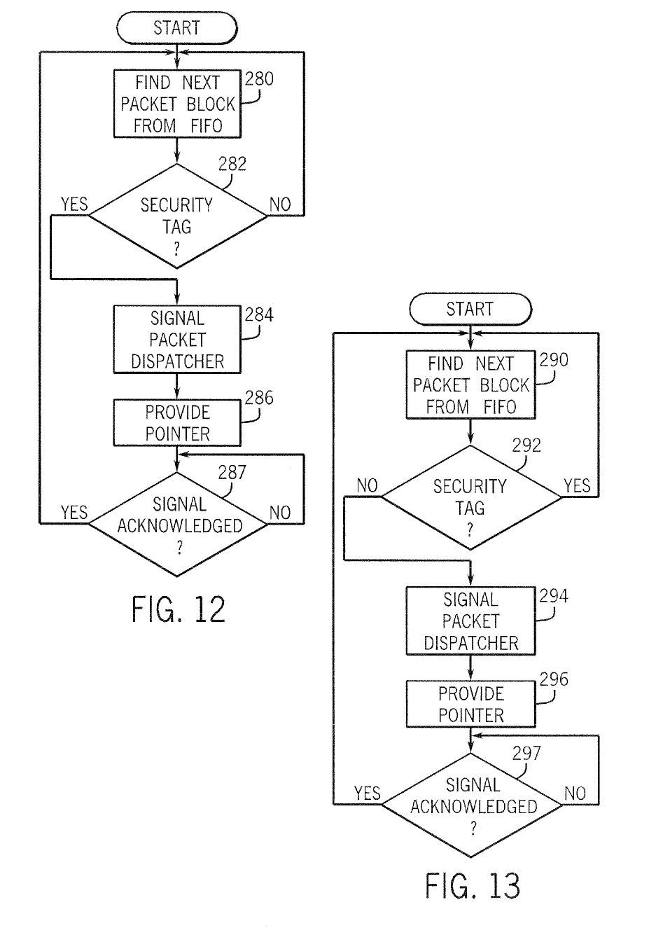

Thus, referring to FIG. 12, the security packet queue control circuit 119 may, in some embodiments, operate in the following manner. First, the circuit 119 may find (block 280) the next packet block from the FIFO memory 122. Next, the circuit 119 may determine (diamond 282) whether the packet block indicates an embedded security tag. If not, then the circuit 119 finds the next packet block, as indicated in block 280. Otherwise, the circuit 119 signals (block 284) the packet dispatcher circuit 127 and provides (block 286) the pointer to the located security packet to the packet dispatcher circuit 127. Subsequently, the circuit 119 may determine (diamond 287) whether the signal that the circuit 119 provided to the packet dispatcher circuit 127 has been acknowledged. If so, the circuit 119 returns to block 280.

Referring to FIG. 13, the non-security packet queue control circuit 117 may, in some embodiments, operate in the following manner. First, the circuit 117 may find (block 290) the next packet block from the FIFO memory 122. Next, the circuit 117 may determine (diamond 292) whether the packet block indicates an embedded security tag. If so, then the circuit 117 finds the next packet block, as indicated in block 290. Otherwise, the circuit 117 signals (block 294) the packet dispatcher circuit 127 and provides (block 296) the pointer to the located security packet to the packet dispatcher circuit 127. Subsequently, the circuit 117 may deteimine (diamond 297) whether the signal that the circuit 117 provided to the packet dispatcher circuit 127 has been acknowledged. If so, the circuit 117 returns to block 290.

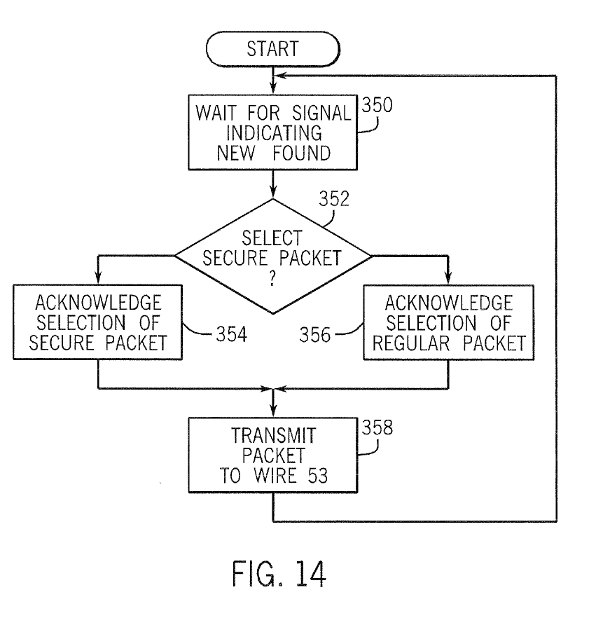

Referring to FIG. 14, the packet dispatcher circuit 127 may wait (block 350) for one or more signals from the circuits 117 and 119 that indicate that a new packet block has been found. Upon this occurrence, the packet dispatcher circuit 127 may determine (diamond 352) whether the packet dispatcher circuit 127 should select the pointer that is provided by the circuit 119 by using a selection technique like the one described above, for example. If so, the circuit 127 acknowledges (block 354) the pointer that is provided by the circuit 119 and transmits (block 358) the packet block (that is indicated by the pointer) to the network wire 53 via the parallel-to-serial conversion circuit 128 and the network interface 90. Otherwise, the circuit 127 acknowledges (block 356) the pointer that is provided by the circuit 117 and transmits (block 358) the packet block (that is indicated by the pointer) to the network wire 53 via the parallel-to-serial conversion circuit 128 and the network interface 90.

The authentication and encryption engine 126 may use keys to encrypt the data of the outgoing packets. In this manner, all packets of a particular flow may be encrypted via a key that is associated with the flow, and the keys for the different flows may be stored in a key memory 124 (FIG. 5). The key memory 124 may be accessed (by execution of the driver program 57, for example) via the PCI interface 130.

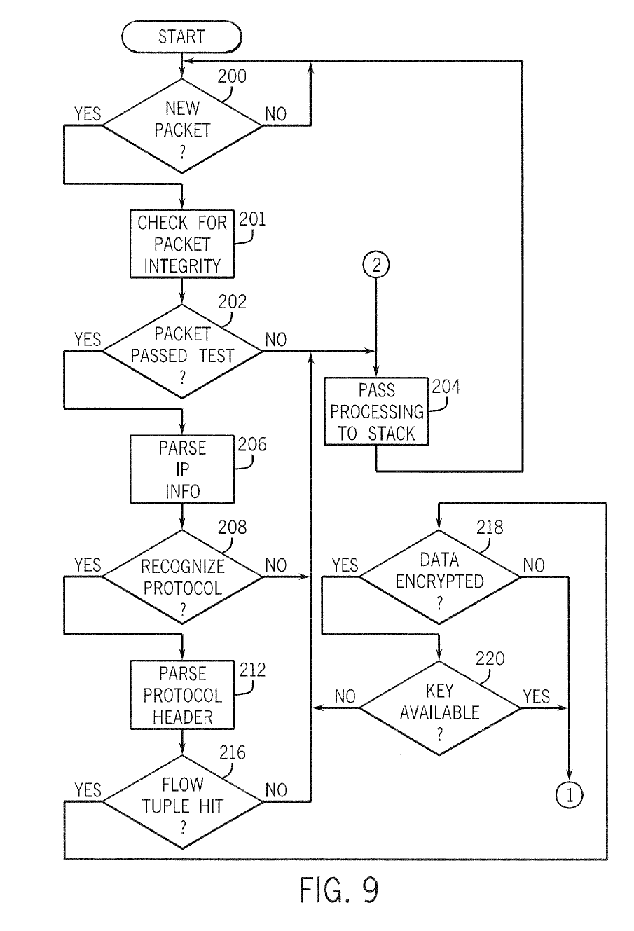

In some embodiments, the receive parser 98 may include one or more state machines, counter(s) and timer(s), as examples, to perform the following functions. In particular, referring to FIG. 9, the receive parser 98 may continually check (block 200) for another unparsed incoming packet. When another packet is to be processed, the receive parser 98 may check the integrity of the packet, as indicated in block 201. For example, the receive parser 98 may determine if the incoming packet includes an IP header and determine if a checksum of the IP header matches a checksum that is indicated by the IP header. If the receive parser 98 determines (diamond 202) that the incoming packet passes this test, then the receive parser 98 may parse (block 206) the header to extract the IP components of a header of the packet to obtain the information needed to determine if a flow tuple hit occurs. For example, the receive parser 98 may extract the network protocol being used, IP destination and source addresses, and the port destination and source addresses. Next, the receive parser 98 may determine if the network protocol is recognized, as indicated in diamond 208. If not, then the receive parser 98 may pass (block 204) further control of the processing to the network stack.

The receive parser 98 may subsequently parse (block 212) the protocol header. As an example, if the packet is associated with the TCP/IP protocol, then the receive parser 98 may parse the TCP header of the packet, an action that may include extracting the TCP ports and security attributes of the packet, as examples. The receive parser 98 uses the parsed information from the protocol header to determine (diamond 216) if a flow tuple hit has occurred. If not, the receiver parser 98 passes control of further processing of the packet to the stack, as depicted in block 204. Otherwise, the receive parser 98 determines (diamond 218) if the data portion of the packet needs to be decrypted. If so, the receive parser 98 determines if the associated key is available in the key memory 104, as depicted in diamond 220. If the key is not available, then the receive parser 98 may return to block 204 and thus, pass control of further processing of the packet to the stack.

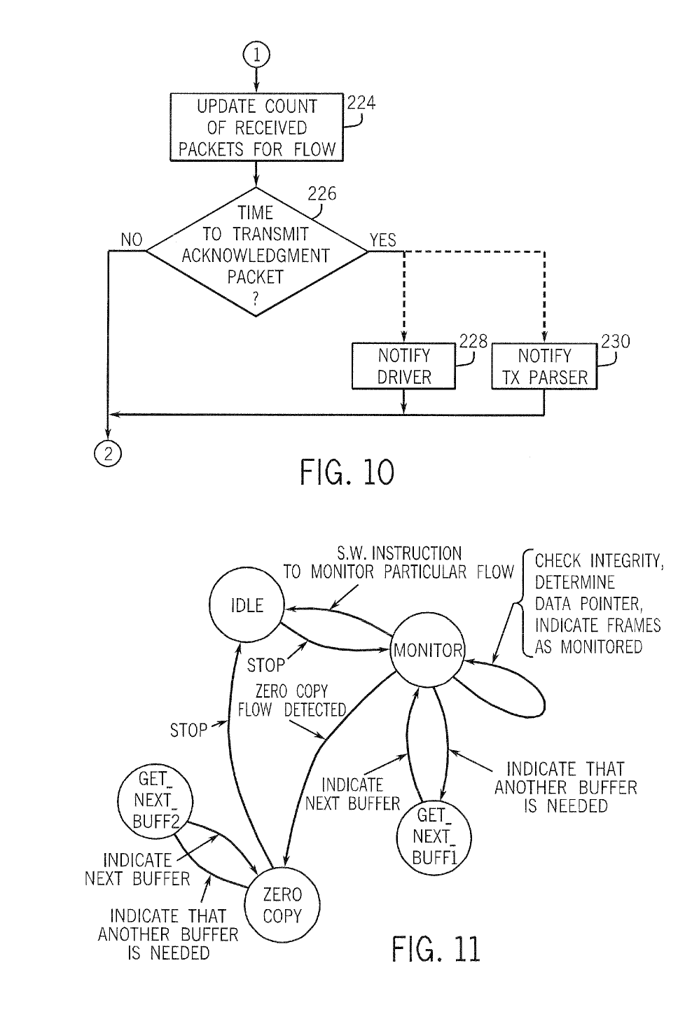

Referring to FIG. 10, if the key is available, the receive parser 98 may update a count of the number of received packets for the associated flow, as depicted in block 224. Next, the receive parser 98 may determine (diamond 226) whether it is time to transmit an acknowledgment packet back to the sender of the packet based on the number of received packets in the flow. In this manner, if the count exceeds a predetermined number that exceeds the window (i.e., if the amount of unacknowledged transmitted data exceeds the window), then the receive parser 98 may either (depending on the particular embodiment) notify (block 228) the driver program 57 (see FIG. 4) or notify (block 230) the transmit parser 114 of the need to transmit an acknowledgment packet. Thus, in the latter case, the transmit parser 114 may be adapted to generate an acknowledgment packet, as no data for the data portion may be needed from the application layer. The receive parser 98 transitions from either block 228 or 230 to diamond 200 to check for another received packet. After an acknowledgment packet is transmitted, the receive parser 98 may clear the count of received packets for that particular flow.

Referring to FIG. 11, in some embodiments, the zero copy parser 110 may include one or more state machines, timer(s) and counter(s) to perform the following functions to transfer the packet data directly to the buffers 304. First, the zero copy parser 110 may determine if control of the transfer needs to be synchronized between the zero copy parser 110 and the stack. In this context, the term “synchronization” generally refers to communication between the stack and the zero copy parser 110 for purposes of determining a transition point at which one of the entities (the stack or the zero copy parser 110) takes control from the other and begins transferring data into the buffers 304. Without synchronization, missing packets may not be detected. Therefore, when control passes from the stack to the parser 110 (and vice versa), synchronization may need to occur, as depicted in block 254.

Thus, one scenario where synchronization may be needed is when the zero copy parser 110 initially takes over the function of directly transferring the data portions into the buffers 304. In this manner, if the zero copy parser 110 determines (diamond 250) that the current packet is the first packet being handled by the zero copy parser 110, then the parser 110 synchronizes the packet storage, as depicted by block 254. For purposes of determining when the transition occurs, the zero copy parser 110 may continually monitor the status of a bit that may be selectively set by the driver program 57, for example. Another scenario where synchronization is needed is when an error occurs when the zero copy parser 110 is copying the packet data into the buffers 304. For example, as a result of the error, the stack may temporarily resume control of the transfer before the zero copy parser 110 regains control. Thus, if the zero copy parser 110 determines (diamond 252) that an error has occurred, the zero copy parser 110 may transition to the block 254.

Synchronization may occur in numerous ways. For example, the zero copy parser 110 may embed a predetermined code into a particular packet to indicate to the stack that the zero copy parser 110 handles the transfer of subsequent packets. The stack may do the same.

Occasionally, the incoming packets of a particular flow may be received out of sequence. This may create a problem because the zero copy parser 110 may store the data from sequential packets one after the other in a particular buffer 304. For example, packet number “267” may be received before packet number “266,” an event that may cause problems if the data for packet number “267” is stored immediately after the data for packet number “265.” To prevent this scenario from occurring, in some embodiments, the zero copy parser 110 may reserve a region 308 (see FIG. 7) in the particular buffer 304 for the missing packet data, as indicated in block 260 (FIG. 11). For purposes of determining the size of the missing packet (and thus, the amount of memory space to reserve), the zero copy parser 110 may use the acknowledgment numbers that are indicated by the adjacent packets in the sequence. In this manner, the acknowledgment number indicates the byte number of the next successive packet. Thus, for the example described above, the acknowledgment numbers indicated by the packet numbers “265” and “267” may be used to determine the boundaries of the region 308.

The zero copy parser 110 subsequently interacts with the PCI interface 130 to set up the appropriate DMA channel to perform a zero copy (step 262) of the packet data into the appropriate buffer 304. The zero copy parser 110 determines the appropriate buffer 304 via the destination port that is provided by the receive parser 98.

Referring back to FIG. 4, besides the network controller 52, the computer system 50 may include a processor 54 that is coupled to a host bus 58. In this context, the term “processor” may generally refer to one or more central processing units (CPUs), microcontrollers or microprocessors (an X86 microprocessor, a Pentium microprocessor or an Advanced RISC Controller (ARM), as examples), as just a few examples. Furthermore, the phase “computer system” may refer to any type of processor-based system that may include a desktop computer, a laptop computer, an appliance or a set-top box, as just a few examples. Thus, the invention is not intended to be limited to the illustrated computer system 50 but rather, the computer system 50 is an example of one of many embodiments of the invention.

The host bus 58 may be coupled by a bridge, or memory hub 60, to an Advanced Graphics Port (AGP) bus 62. The AGP is described in detail in the Accelerated Graphics Port Interface Specification, Revision 1.0, published in Jul. 31, 1996, by Intel Corporation of Santa Clara, Calif. The AGP bus 62 may be coupled to, for example, a video controller 64 that controls a display 65. The memory hub 60 may also couple the AGP bus 62 and the host bus 58 to a memory bus 61. The memory bus 61, in turn, may be coupled to a system memory 56 that may, as examples, store the buffers 304 and a copy of the driver program 57.

The memory hub 60 may also be coupled (via a hub link 66) to another bridge, or input/output (I/O) hub 68, that is coupled to an I/O expansion bus 70 and the PCI bus 72. The I/O hub 68 may also be coupled to, as examples, a CD-ROM drive 82 and a hard disk drive 84. The I/O expansion bus 70 may be coupled to an I/O controller 74 that controls operation of a floppy disk drive 76 and receives input data from a keyboard 78 and a mouse 80, as examples.

Other embodiments are within the scope of the following claims. For example, a peripheral device other than a network controller may implement the above-described techniques. Other network protocols and other protocol stacks may be used.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. An article comprising a medium for storing instructions that cause a processor-based system to:
send a first request from a network driver of a host to a network controller, the first request requesting storage of at least one cryptographic key associated at least in part with a flow identified by, at least, an Internet Protocol source and Internet Protocol destination address, the host to provide a Transmission Control Protocol/Internet Protocol (TCP/IP) protocol stack;
receive from the network controller, ingress Internet Protocol packets having data authenticated and decrypted by the network controller in accordance with, at least, the at least one cryptographic key, the associated Internet Protocol destination address, and security attributes stored in a field within the Internet Protocol packet; and
send a second request from the network driver of the host to the network controller to the network controller requesting deletion of the at least one cryptographic key.

2. The article of claim 1, further storing instructions for causing the processor-based system to:
send Internet Protocol packets to the network controller for encryption by the network controller in accordance with at least one cryptographic key sent by the network driver to the network controller.

3. The article of claim 2, further storing instructions for causing the processor-based system to:
receive from the network controller an Internet Protocol packet having encrypted data and security attributes associated with the encrypted data stored in the field within thc Internet Protocol packet, the Internet Protocol packet associated with thc at least one cryptographic key identified in the second request.

4. A network controller, comprising:
a host interface;
an interface to a network connection;
logic to:
receive a first request from a network driver of a host to a network controller, the first request requesting storage of at least one cryptographic key associated at least in part with a flow identified by, at least, an Internet Protocol source and Internet Protocol destination address, the host to provide a Transmission Control Protocol/Internet Protocol (TCP/IP) protocol stack;
send to the host via the host interface ingress Internet Protocol packets having data authenticated and decrypted by the network controller in accordance with, at least, the at least one cryptographic key received in the first request, the associated Internet Protocol destination address, and security attributes stored in a field within the Internet Protocol packet; and
receive a second request from the network driver of the host to the network controller to the network controller requesting deletion of the at least one cryptographic key.

5. The network controller of claim 4, wherein the logic comprises logic to:
encrypt data of Internet Protocol packets received by the network controller via the host interface in accordance with at least one cryptographic key received by the network controller from the host.

6. The network controller of claim 4, wherein the logic comprises logic to:
send to the host via the host interface an Internet Protocol packet having encrypted data and security attributes associated with the encrypted data stored in the field within the Internet Protocol packet, the Internet Protocol packet associated with the at least one cryptographic key identified in the second request.

7. A method comprising:
sending a first request from a network driver of a host to a network controller, the first request requesting storage of at least one cryptographic key associated at least in part with a flow identified by, at least, an Internet Protocol source and Internet Protocol destination address, the host to provide a Transmission Control Protocol/Internet Protocol (TCP/IP) protocol stack;
receiving from the network controller, ingress Internet Protocol packets having data authenticated and decrypted by the network controller in accordance with, at least, the at least one cryptographic key, the associated Internet Protocol destination address, and security attributes stored in a field within the Internet Protocol packet; and
sending a second request from the network driver of the host to the network controller to the network controller requesting deletion of the at least one cryptographic key.

8. The method of claim 7, further comprising:
sending Internet Protocol packets to the network controller for encryption by the network controller in accordance with at least one cryptographic key sent by the network driver to the network controller.

9. The method of claim 7, further comprising:
receiving from the network controller an Internet Protocol packet having encrypted data and security attributes associated with the encrypted data stored in the field within the Internet Protocol packet, the Internet Protocol packet associated with the at least one cryptographic key identified in the second request.

10. A method, comprising:
receiving a first request from a network driver of a host to a network controller, the first request requesting storage of at least one cryptographic key associated at least in part with a flow identified by, at least, an Internet Protocol source and Internet Protocol destination address, the host to provide a Transmission Control Protocol/Internet Protocol (TCP/IP) protocol stack;
sending to the host via the host interface ingress Internet Protocol packets having data authenticated and decrypted by the network controller in accordance with, at least, the at least one cryptographic key received in the first request, the associated Internet Protocol destination address, and security attributes stored in a field within the Internet Protocol packet; and
receiving a second request from the network driver of the host to the network controller to the network controller requesting deletion of the at least one cryptographic key.

11. The method of claim 10, further comprising:
encrypting data of Internet Protocol packets received by the network controller via the host interface in accordance with at least one cryptographic key received by the network controller from the host.

12. The method of claim 10, further comprising:
sending to the host via the host interface an Internet Protocol packet having encrypted data and security attributes associated with the encrypted data stored in the field within the Internet Protocol packet, the Internet Protocol packet associated with the at least one cryptographic key identified in the second request.
